(19) United States
(12) Patent Application Publication
(10) Pub. No.: US 2023/0187787 A1
(43) Pub. Date: Jun. 15, 2023

(54) MOTOR VEHICLE TRACTION BATTERY ASSEMBLY

(71) Applicant: Dr. Ing. h.c. F. Porsche Aktiengesellschaft, Stuttgart (DE)

(72) Inventor: Jens Krüger, Bönnigheim (DE)

(73) Assignee: Dr. Ing. h.c. F. Porsche Aktiengesellschaft, Stuttgart (DE)

(21) Appl. No.: 18/079,173

(22) Filed: Dec. 12, 2022

(30) Foreign Application Priority Data
Dec. 14, 2021 (DE) 10 2021 133 014.9

(51) Int. Cl. H01M 50/507; B60L 50/64; B60L 58/10; H01M 50/30

(52) U.S. Cl. CPC H01M 50/507; B60L 50/64; B60L 58/10; H01M 50/30; H01M 2220/20

(57) ABSTRACT

A motor vehicle traction battery assembly has a battery control unit and battery modules. Each battery module includes a degassing opening. A plurality of busbars is arranged in a rail tunnel, to which the battery modules are electrically connected. The rail tunnel is fluidly shielded by a tunnel lid. The battery control unit includes an interior having a gas-tight battery control unit housing body in which connection rails and an electronic battery controller are accommodated. The electrical connections between the busbars and the connection rails are formed by vertical contact bodies, which pass through a connection opening lying in the horizontal plane between the rail tunnel and the battery control unit interior. The connection opening is fluidly sealed by a sealing wall, through which the contact bodies pass in a fluid-tight manner.

### CROSS-REFERENCE TO RELATED APPLICATION

This application claims priority to German Patent Application No. 10 2021 133 014.9, filed Dec. 14, 2021, the content of such application being incorporated by reference herein in its entirety.

### FIELD OF THE INVENTION

The invention relates to a motor vehicle traction battery assembly for a motor vehicle having an electrical traction drive.

### BACKGROUND OF THE INVENTION

A traction battery assembly consists essentially of a plurality of battery modules and a central battery control unit. Such traction battery assemblies are known, among others, from DE 10 2018 101 115 A1, DE 10 2019 128 946 B3, and DE 10 2019 220 034 A1, each of which is incorporated by reference herein in its entirety.

### SUMMARY OF THE INVENTION

In passenger cars in particular, the traction battery is typically constructed laminarly and is accommodated in the floor region of the motor vehicle. The battery portion of the traction battery is composed of a plurality of battery modules arranged in a horizontal plane adjacent to one another and arranged in two or three rows extending in the longitudinal vehicle direction, each having a plurality of battery modules. A battery control unit is arranged longitudinally behind the rear end or in front of the front end of all battery modules and monitors the battery modules.

A rail tunnel running in the longitudinal vehicle direction is provided between two battery module rows, against which rail tunnel the battery modules directly abut and in which a plurality of busbars extending in the longitudinal vehicle direction are accommodated, that establish the electrical connection between the battery modules and the battery control unit. The rail tunnel opens into the housing of the battery control unit.

Depending on the type, chemistry, and design of the battery cells of the battery modules, outgassing occurs over the battery module lifetime, wherein the gases escaping from the battery module can form a combustible gas mixture.

Among other things, the battery control unit has a protective function and therefore comprises a contactor switch so as to be able to electrically insulate the battery modules in a protection event, for example in a detected vehicle crash. Because electrical arcs occur when switching high voltages, the contactor switches must be gas-tightly encapsulated by corresponding switch housings against the potentially flammable gas mixture. By providing switch housings, the contactor switches are relatively bulky.

In light of the foregoing, described herein is a motor vehicle traction battery assembly with a plurality of battery modules and a compact battery control unit.

The motor vehicle traction battery assembly according to aspects of the invention comprises a plurality of battery modules, which themselves each comprise a degassing opening through which they can degas. The battery modules are electrically connected to an adjacent battery control unit. For this purpose, a rail tunnel running in the longitudinal vehicle direction is provided, against which the battery modules fluidly directly abut so that a gas leaking from a degassing opening of a battery module enters into the rail tunnel. A plurality of busbars extend in the rail tunnel, to which busbars the battery modules are directly or indirectly electrically connected and which establish the electrical connection between the battery modules and the battery control unit. The rail tunnel is fluidly shielded against the environment by a tunnel lid, so that gas cannot escape in this region. In this way, gases are prevented from escaping out of the rail tunnel into the vehicle interior.

The battery control unit comprises an interior consisting of a gas-tight battery control unit housing body, in which electrical connection rails and an electronic battery controller are accommodated. The battery controller monitors the battery modules and electrically insulates the battery modules in the event of a vehicle crash.

The ends of the busbars on the one hand and the corresponding ends of the opening on the other hand are electrically connected to one another by vertical contact bodies, for example in that the contact bodies are reliably electrically connected to the respective ends of the busbar and the terminal bar via a plug-in connection, a screw connection, or a material-locking connection. The contact bodies protrude through a connection opening located substantially in a horizontal plane between the rail tunnel and the battery control unit interior and in this way connect the busbars and connection rails located in different horizontal planes.

According to aspects of the invention, it is provided that this connection opening is fluidly sealed by a separate sealing wall, so that no gases from the rail tunnel can enter the housing body interior of the battery control unit. In this way, the ignition hazard and the fire hazard due to flammable gases entering the battery control unit from the battery modules is completely eliminated. The protective measures against flammable gases in the battery control unit can thus be reduced accordingly.

It is preferably provided that the sealing wall is formed by a plastic body, which is fixed, for example, in a positive-locking, material-locking, or force-locking manner. For example, elastomers, for example thermoplastic elastomers (TPE), can be considered as plastics.

Particularly preferably, the sealing wall or the plastic body forming the sealing wall forms sleeve-shaped insulation shells that respectively cylindrically surround or wrap the pin-like contact bodies, namely at least over the majority of the contact body length. An electrical contact protection with respect to the contact bodies is thereby realized. Further, a long sealing gap between the insulation shell and the contact body that largely surrounds the contact body is realized, so that a passage of gas through the ring gap between the insulation shell and the contact body is excluded.

Preferably, the sealing wall comprises a mechanical stiffening element embedded in the plastic body. The relatively thin plastic sealing wall does not exhibit high stability in the normal direction. The mechanical stability of the sealing wall in the normal direction is significantly improved by the stiffening element, which can consist of an embedded metal body, for example.

Preferably, the battery control unit comprises at least one non-shielded contactor switch that is not encapsulated against ambient gases. Because the sealing wall excludes an entry of flammable gases that can result from an outgassing of a battery cell, a gas-tight housing for each contactor switch can be omitted. Because the battery control unit typically has four to six or more contactor switches, the battery control unit can be realized significantly more compactly.

Preferably, the sealing wall forms a flange seal between a flange of the tunnel lid and a flange of the battery control unit housing body. A separate flange seal for a gas-tight sealing of the interface between the tunnel lid and the battery control unit housing body is therefore no longer required. The actual flange seal can consist of a different material than the sealing body of the sealing wall lying in the connection opening and can be connected to the sealing body, for example, by means of a two-component injection molding in a material-locking manner.

### BRIEF DESCRIPTION OF THE DRAWINGS

An exemplary embodiment of the invention will be explained in further detail in the following with reference to the drawings. The figures show:

FIG. 1 a perspective view of a motor vehicle traction battery assembly having twelve battery modules and a front-face battery control unit,

FIG. 2 a vertical cross-section II-II of the battery control unit of FIG. 1, and FIG. 3 a vertical longitudinal section III-III of the traction battery assembly of FIG. 1.

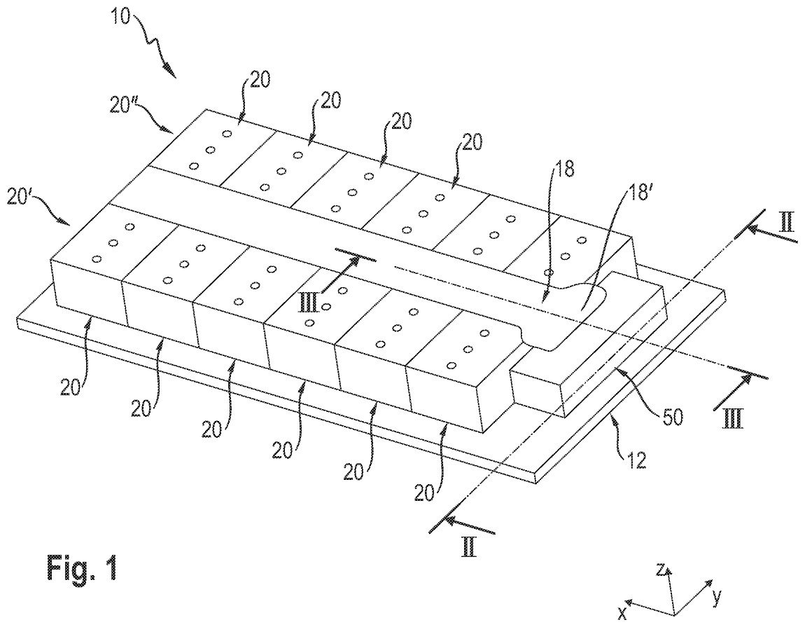

### DETAILED DESCRIPTION OF THE INVENTION

The figures show a motor vehicle traction battery assembly 10, which is formed substantially by two longitudinal rows 20′, 20″, each having six battery modules 20 and one battery control unit 50 centrally abutting the two battery module longitudinal rows 20′, 20″.

All battery modules 20 and battery control unit 50 lie on a single horizontal plane XY. The battery modules 20, which are identical to one another, are each elongated in the shape of a flat bolt, wherein their small end faces 21 lie in the vertical longitudinal plane XZ. The proximal end faces 21 of the battery modules 20 each have a degassing opening 22, through which the battery modules 20 can degas into a rail tunnel 14.

Above the battery modules 20, there is provided the rail tunnel 14, which extends in the longitudinal vehicle direction X and in which a plurality of busbars 16 are arranged in the longitudinal direction, with which the battery modules 20 are each directly or indirectly electrically connected. The rail tunnel 14 is shielded against the environment in a fluid-tight manner by a lid 18 that is centered with respect to the vehicle, elongated, and positioned on top. Beneath the battery modules 20 and the battery control unit 50, an actively liquid-cooled heat sink plate 12 is provided.

In an interior 53 consisting of a gas-tight metal housing body 52, the battery control unit 50 comprises an electronic battery controller 54 comprising a plurality of contactor switches 56. The battery controller 54 comprises connection rails 58 corresponding to the busbars 16, which rails are electrically connected to one another by a vertical and electrically conductive contact body 30. With its upper end, the contact body 30 is inserted, for example pressed, into a respective receptacle 32, which is connected to the relevant busbar 16.

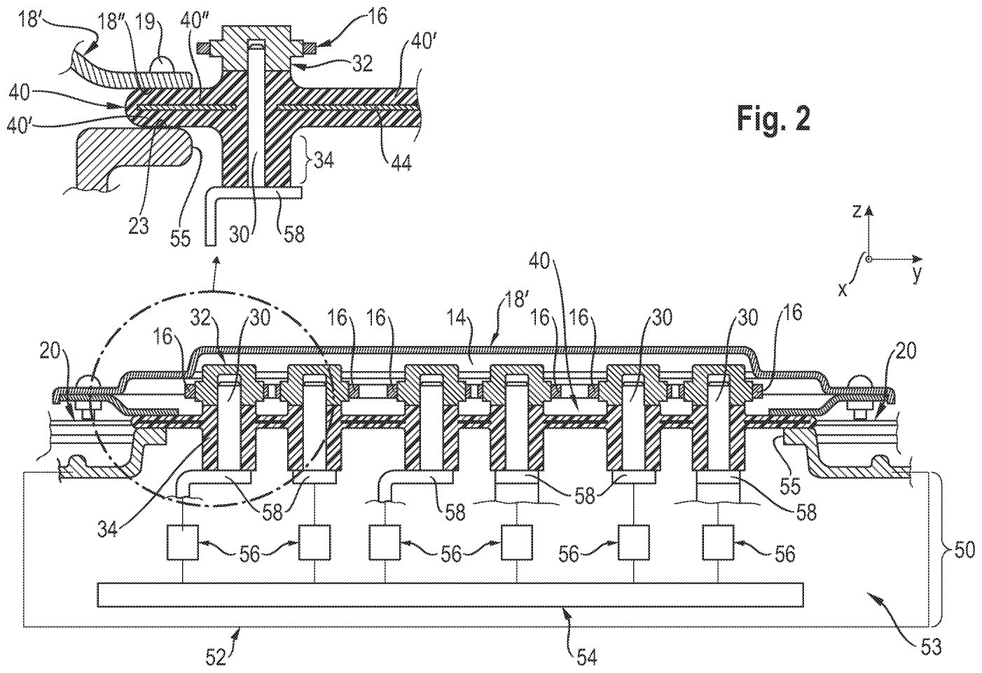

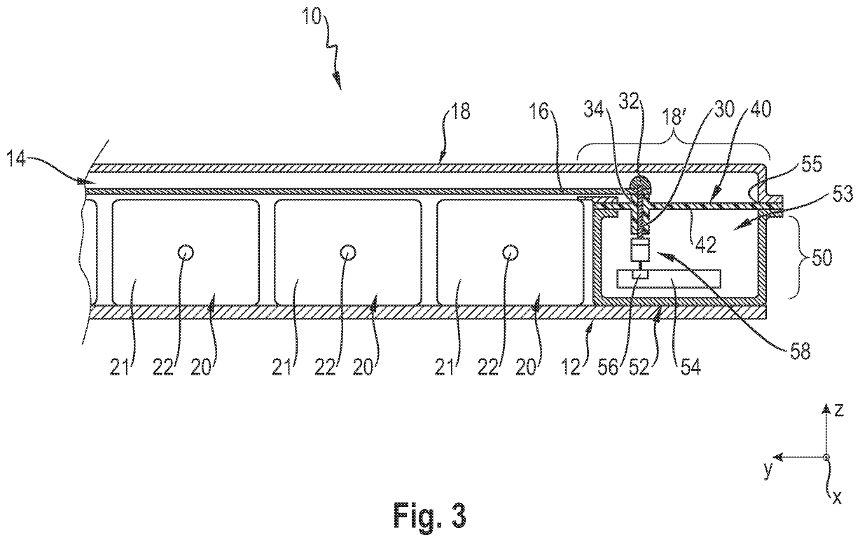

As shown in FIGS. 2 and 3, a connection opening 55 lying in the horizontal plane XY is defined between the rail tunnel 14 and the battery control unit interior 53, through which opening the vertical contact bodies 30 pass.

A fluid-tight sealing wall 40 is arranged in the connection opening 55, which fluidly seals the connection opening 55 so that no gases can enter the battery control unit interior 53 from the rail tunnel 14.

The sealing wall 40 is formed by a plastic body 40′, which also forms cylindrical contact sleeves 34, which completely wrap the cylindrical pin-like contact bodies 30 over their circumference and vertical extension, respectively. In the sealing wall plastic body 40′, there is embedded a laminar, metal stiffening element 44 that lies in a horizontal plane XY and stiffens the sealing wall 40 in the normal direction.

The sealing wall 40 further forms a flange seal between a flange 18″ of the portion 18′ of the tunnel lid 18 protruding from the connection opening 55 and a corresponding mating flange 23 of the battery control unit housing body 52. The two flanges 18″, 23 are vertically tensioned with one another by flange bolts 19.

What is claimed is:

1. A motor vehicle traction battery assembly comprising:
a battery control unit comprising a gas-tight battery control unit housing body defining an interior that is sized to accommodate connection rails and an electronic battery controller;
a plurality of battery modules, each comprising a degassing opening and each being electrically connected to the battery control unit;
a rail tunnel extending in a longitudinal vehicle direction that directly abuts the battery modules;
a tunnel lid fluidly shielding the rail tunnel; and
a plurality of busbars arranged in the rail tunnel, the busbars being electrically connected to the battery modules,
wherein electrical connections between the busbars and the connection rails are formed by vertical contact bodies, which pass through a connection opening lying in a horizontal plane between the rail tunnel and the battery control unit interior, and
wherein the connection opening is fluidly sealed by a sealing wall, through which the vertical contact bodies pass in a fluid-tight manner.

2. The motor vehicle traction battery assembly according to claim 1, wherein the sealing wall is a plastic body.

3. The motor vehicle traction battery assembly according to claim 2, wherein the sealing wall forms insulation shells, which respectively surround pin-like bodies of the vertical contact bodies.

4. The motor vehicle traction battery assembly according to claim 2, wherein the sealing wall comprises a stiffening element embedded in the plastic body.

5. The motor vehicle traction battery assembly according to claim 1, wherein the battery control unit further comprises at least one non-shielded contactor switch.

6. The motor vehicle traction battery assembly according to claim 1, wherein the sealing wall forms a flange seal between a flange of the tunnel lid and a mating flange of the battery control unit housing body.

7. A motor vehicle comprising the motor vehicle traction battery assembly of claim 1.
